(19) United States
(12) Patent Application Publication
(10) Pub. No.: US 2021/0309485 A1
(43) Pub. Date: Oct. 7, 2021

(54) Combination Capillary and Cable Spooling System

(71) Applicant: ALS Hotshot, LLC, Dickinson, ND (US)

(72) Inventor: Joseph K. Claiborne, Dickinson, ND (US)

(21) Appl. No.: 16/839,687

(22) Filed: Apr. 3, 2020

(51) Int. Cl. B65H 75/42; E21B 19/22; B60P 3/035; B65H 75/44; B65H 59/40

(52) U.S. Cl. CPC B65H 75/425; E21B 19/22; B65H 59/40; B65H 75/4489; B60P 3/035

(57) ABSTRACT

A combination capillary and cable spooling system for efficiently unspooling or spooling capillary and cable with respect to a workover rig. The combination capillary and cable spooling system generally includes a motorized vehicle having a platform, a first spool support attached to the upper surface of the platform adapted to rotatably support a first spool having a capillary line, a first motor attached to the first spool support to rotate the first spool, a second spool support attached to the upper surface of the platform to rotatably support a second spool having a cable line, and a second motor attached to the second spool support to rotate the second spool.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a combination capillary and cable spooling system for efficiently unspooling or spooling capillary string and cable with respect to a workover rig.

### Related Art

Any discussion of the related art throughout the specification should in no way be considered as an admission that such related art is widely known or forms part of common general knowledge in the field.

Workover rigs are used to service and complete oil and gas wells after drilling processes have finished. There are several different types of methods and systems used to complete a well and get it ready for production. When an electrical submersible pump (ESP) system is used, a capillary string control line and an electrical power cable line are secured to the production tubing during the installation of the ESP and associated components into the well. When removing the ESP and production tubing from a well, the capillary line and the cable line previously attached to the tubing must be removed and spooled for diagnostics and later usage. A capillary spool is typically positioned upon a first trailer with two workers to operate the unit and a cable spool is positioned upon a second trailer with an additional two workers to operate that unit. A first vehicle pulls the first trailer and a second vehicle pulls the second trailer to a workover rig to either unspool or spool the capillary line and the cable line.

There are several problems with the conventional system. One problem is that two separate pieces of equipment and a total of four workers are used to feed capillary line and cable line into the well during insertion (or removal) of the tubing. The two separate pieces of equipment and four workers are not only expensive to operate but also require a significant amount of ground space near the workover rig. Ground space can be limited on smaller well pads and over crowding decreases mobility during the event of an accident. Another issue is the vehicle and spool trailer set up can potentially be fatal to any worker on or in between the trailer and workover rig. In the event that the ESP and associated components becomes dislodged or dropped uncontrollably down the well, usually caused by a component of the workover rig breaking, the vehicle and trailer set up is not heavy enough to overcome the force resulting in the vehicle and trailer to slam into the workover rig.

### SUMMARY

An example embodiment is directed to a combination capillary and cable spooling system. The combination capillary and cable spooling system includes a motorized vehicle having a platform, a first spool support attached to the upper surface of the platform adapted to rotatably support a first spool having a capillary line, a first motor attached to the first spool support to rotate the first spool, a second spool support attached to the upper surface of the platform to rotatably support a second spool having a cable line, and a second motor attached to the second spool support to rotate the second spool.

There has thus been outlined, rather broadly, some of the embodiments of the combination capillary and cable spooling system in order that the detailed description thereof may be better understood, and in order that the present contribution to the art may be better appreciated. There are additional embodiments of the combination capillary and cable spooling system that will be described hereinafter and that will form the subject matter of the claims appended hereto. In this respect, before explaining at least one embodiment of the combination capillary and cable spooling system in detail, it is to be understood that the combination capillary and cable spooling system is not limited in its application to the details of construction or to the arrangements of the components set forth in the following description or illustrated in the drawings. The combination capillary and cable spooling system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a side view of a combination capillary and cable spooling system unspooling capillary line and cable line to a workover rig in accordance with an example embodiment.

FIG. 2 is a rear upper perspective view of a combination capillary and cable spooling system loading a cable spool in accordance with an example embodiment.

FIG. 3 is a rear upper perspective view of a combination capillary and cable spooling system unspooling capillary line and cable line to a workover rig in accordance with an example embodiment.

FIG. 4 is a rear upper perspective view of the platform of the vehicle.

FIG. 5 is a rear upper perspective view of the platform of the vehicle with the spool supports.

FIG. 6 is a side view of the platform supporting the cable spool and the capillary spool in accordance with an example embodiment.

FIG. 7A is a front view of a ground support unit.

FIG. 7B is a cross sectional view of the ground support unit.

FIG. 7C is an upper perspective view of the ground support unit.

FIG. 8A is an upper perspective view of the spool frame.

FIG. 8B is a top view of the spool frame.

FIG. 8C is a side view of the spool frame.

FIG. 9A is an upper perspective view of the sliding support.

FIG. 9B is a top view of the sliding support.

FIG. 9C is a side view of the sliding support.

FIG. 9D is a rear view of the sliding support.

FIG. 10 is a block diagram of the control unit in communication with the various device of an example embodiment.

### DETAILED DESCRIPTION

### A. Overview.

An example combination capillary and cable spooling system generally comprises a motorized vehicle 30 having a platform 32, a first spool support 50 attached to the upper surface of the platform 32 adapted to rotatably support a first spool 12 having a capillary line 14, a first motor 70 attached to the first spool support 50 to rotate the first spool 12, a second spool support 40 attached to the upper surface of the platform 32 to rotatably support a second spool 16 having a cable line 18, and a second motor 72 attached to the second spool support 40 to rotate the second spool 16.

### B. Motorized Vehicle.

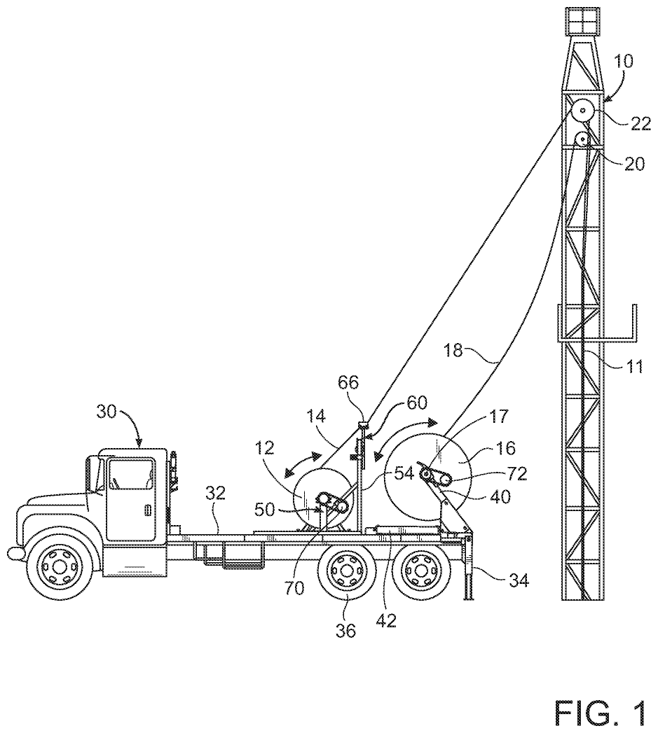

FIGS. 1 through 3 illustrate an exemplary embodiment of a motorized vehicle 30 having a front end, a rear end, a frame, a plurality of wheels 36 and/or a plurality of tracks (not shown). The motorized vehicle 30 may be comprised of any vehicle that is motorized such as a flatbed truck. The motor in the motorized vehicle 30 may be powered by gas, diesel or electrical power. The motor drives the wheels 36 of the motorized vehicle 30 to move the motorized vehicle 30 to a desired location near a workover rig 10 or to load the spools 12, 16. The motorized vehicle 30 may have a cab where one or more workers may sit during transportation and must be compliant with Federal Department of Transportation regulations.

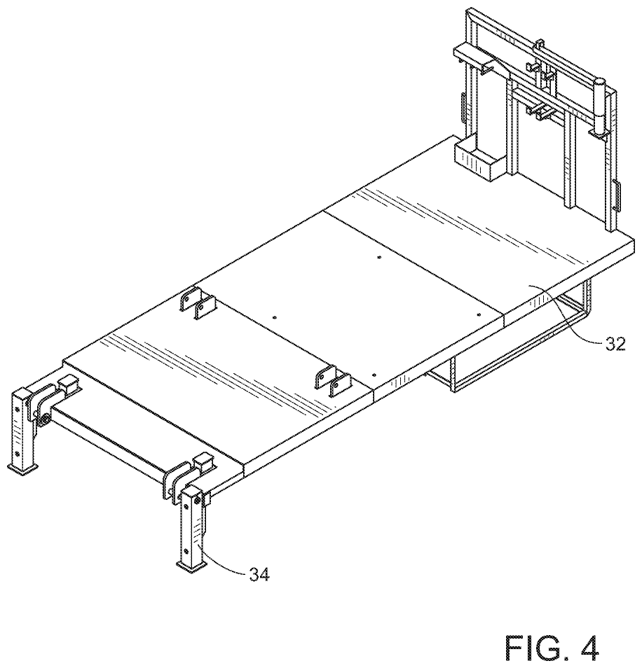

As shown in FIGS. 1 through 6 of the drawings, the motorized vehicle 30 includes a platform 32 attached to the frame having an upper surface where the first spool support 50 and the second spool support 40 are positioned upon. The platform 32 may have a flat upper surface as shown in FIG. 4 of the drawings. The platform 32 is preferably comprised of a rigid material capable of supporting significant amounts of weight involved with support a first spool 12 of capillary line 14 and a second spool 16 of cable line 18 such as metal.

As shown in FIGS. 1 through 7, a plurality of ground support units 34 are attached to the motorized vehicle 30 near the rear end. The ground support units 34 may be attached to the platform 32 or to the frame of the motorized vehicle 30. The plurality of ground support units 34 each are preferably comprised of a telescoping structure that is adapted to engage a ground surface to support a portion of a weight of the motorized vehicle 30. The plurality of ground support units 34 also acts as an additional ground contact points to secure the motorized vehicle 30 in place during spooling or unspooling operations and assists in loading or unloading of the second spool 16.

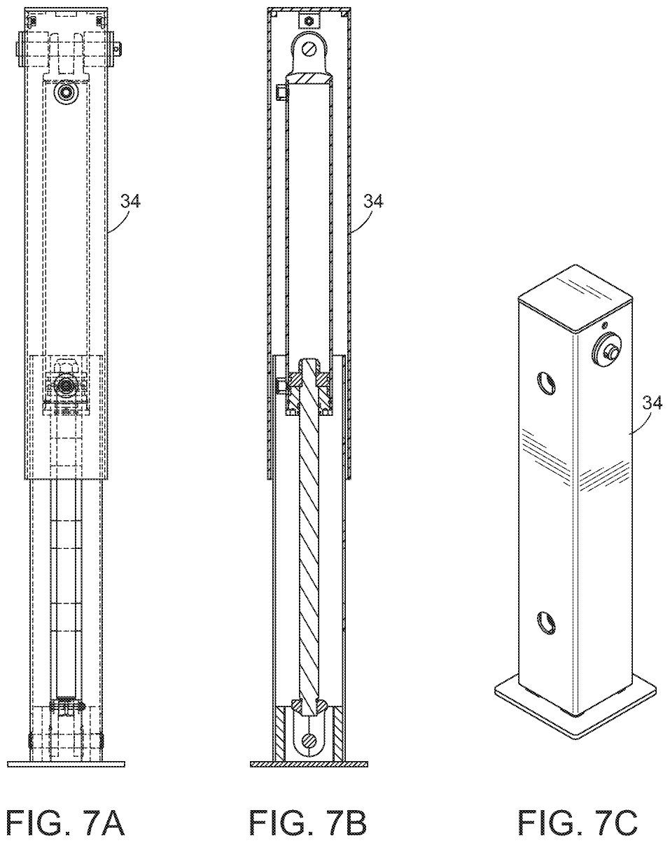

FIGS. 7A through 7C illustrate an exemplary telescoping structure that utilizes an actuator (e.g. hydraulic cylinder, electrical-mechanical actuator) to extend and retract the ground support unit 34. The operator uses the control unit 80 to control the extension and retraction of the ground support units 34. When extended, the ground support units 34 remove some of the weight of motorized vehicle 30 and the spools 12, 16 from the suspension and tires of the motorized vehicle 30. The plurality of ground support units 34 also acts as an additional ground contact points to secure the motorized vehicle 30 in place during spooling or unspooling operations and assists in loading or unloading of the second spool 16.

### C. First Spool Support.

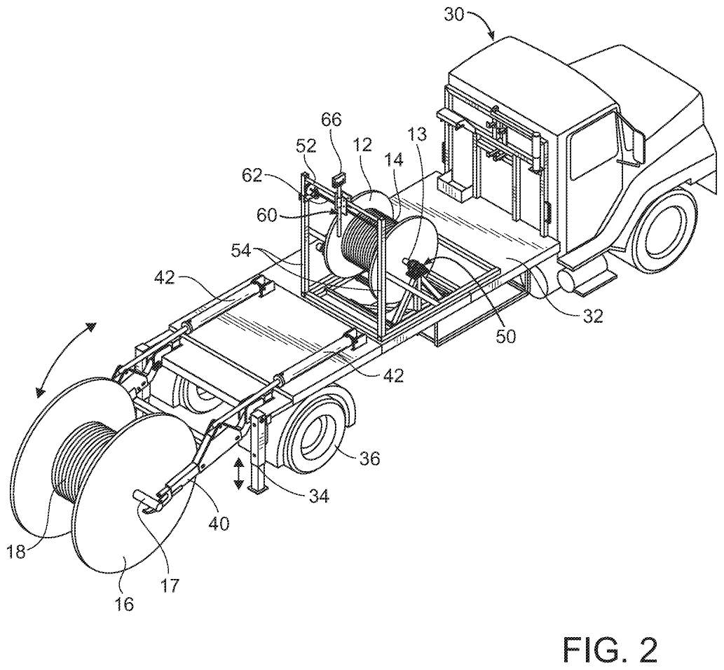

FIGS. 1 through 3, 5 and 6 illustrate a first spool support 50 attached to the platform 32. The first spool support 50 is preferably attached to the upper surface of the platform 32 and extends upwardly from the platform 32. The first spool support 50 rotatably supports a first spool 12 having a length of capillary line 14 that is spooled upon the first spool 12. The first spool 12 includes a first axle 13 (e.g. split axle, single axle) to rotatably support the first spool 12 upon the first spool support 50 as shown in FIG. 2 of the drawings. The first spool 12 may be comprised of any spool structure and may have a central portion with opposing sidewalls defining a channel between the sidewalls that receives the capillary line 14 (a.k.a. injection string, capillary string, capillary tube, injection tube).

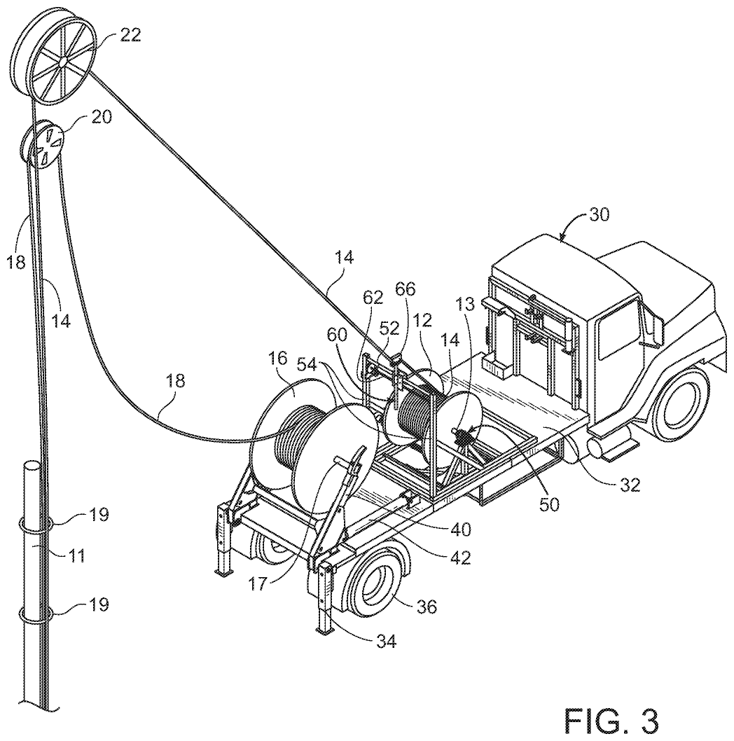

The capillary line 14 is secured to the production tubing 11 used in an oil or gas well to deliver liquid chemicals into the well referred to as downhole chemical injection. The liquid chemical is typically stored in a tank and injected through the capillary line 14 by a chemical pump. The capillary line 14 may be comprised of various types of materials such as, but not limited to, plastic or metal alloy (e.g. stainless steel) that may be encapsulated or PVC coated. The capillary line 14 is wound about the first spool 12 for storage and transportation as shown in FIGS. 2 and 3 of the drawings.

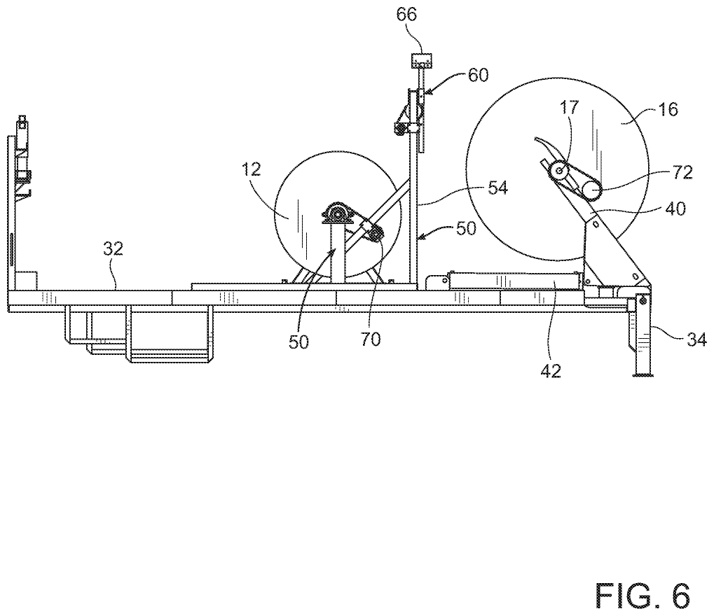

The first spool support 50 includes a pair of vertical supports that support the opposing portions of the first axle 13 extending at least partially through the first spool 12 as shown in FIGS. 1 through 3 and 6 of the drawings. The pair of vertical supports for the first spool support 50 elevate the first spool 12 above the upper surface of the platform 32 to allow for relatively free rotation of the first spool 12 upon the first spool support 50 without touching the upper surface of the platform 32 shown in FIG. 6 of the drawings.

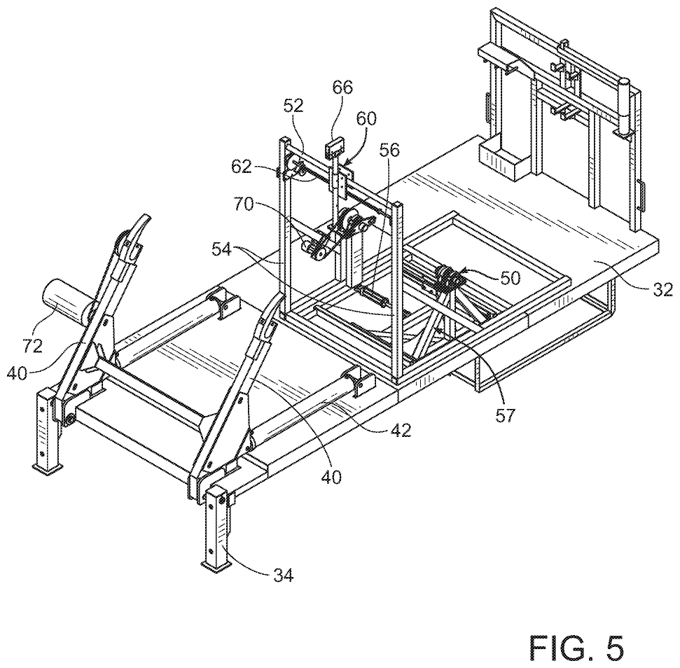

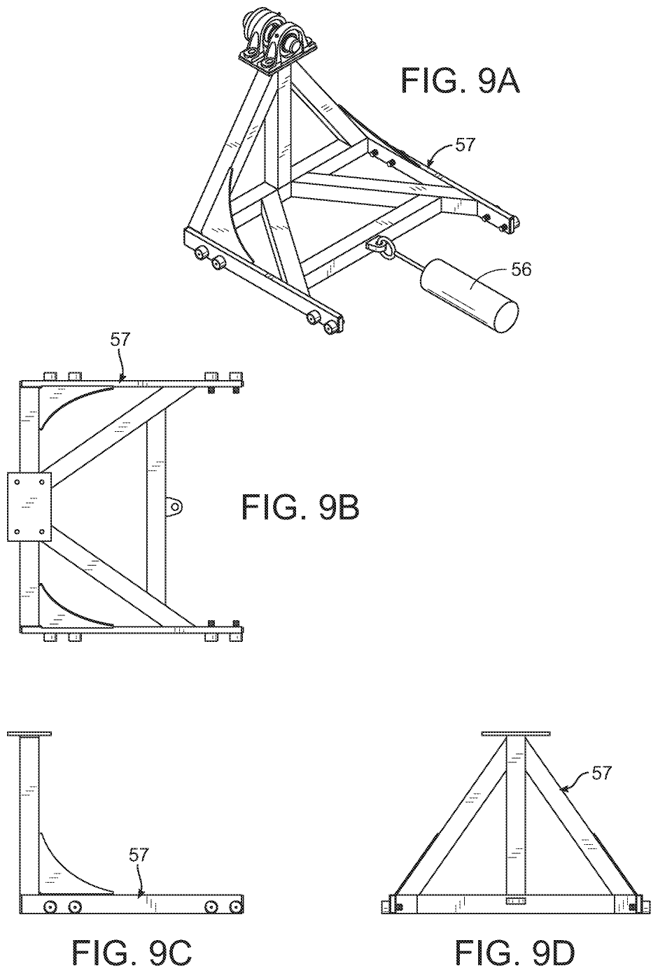

One of the vertical supports for the first spool support 50 may be comprised of a sliding support 57 that is moved inwardly and outwardly by an actuator (e.g. hydraulic cylinder, electrical-mechanical actuator) to allow for easy loading and unloading of the first spool 12. FIGS. 5 and 9A through 9D illustrate an exemplary embodiment showing the sliding support 57.

In one embodiment, the first spool support 50 is aligned so that it supports the first axle 13 in a manner that is orthogonal to the longitudinal axis of the motorized vehicle 30 and the platform 32 of the motorized vehicle 30 as shown in FIGS. 2 and 3 of the drawings. Aligning the first axle 13 of the first spool 12 orthogonally with respect to the longitudinal axis of the motorized vehicle 30 allows the motorized vehicle 30 to position itself with the rear end of the motorized vehicle 30 near the workover rig 10 to save space near the workover rig 10 and to allow the capillary line 14 to be dispensed (or collected) from the rear end of the motorized vehicle 30 as shown in FIGS. 1 and 3 of the drawings. Alternatively, the spools 12, 16 may be aligned perpendicularly on the truck platform.

A first motor 70 is preferably attached to the first spool support 50 or the platform 32 in an exemplary embodiment. The first motor 70 is adapted to be connected to the first spool 12 to rotate the first spool 12 about a first axis longitudinally extending through the first axle 13. The first motor 70 is preferably adapted to rotate the first spool 12 in a first direction to unspool the capillary line 14 from the first spool 12 when installing tubing 11 to a well and a second direction to spool the capillary line 14 upon the first spool 12 for when removing tubing 11 from a well. The operator selects the rotational direction for the spool via the control panel 80. The first motor 70 may be allowed to freely rotate in the first direction to unspool the capillary line 14 with a preferred tension as the rig lowers the tubing which pulls the capillary line 14 from the first spool 12 without the motor being activated thereby maintaining a desired uptake tension to keep the capillary line 14 tight. Alternatively, the first motor 70 may be activated to rotate in the first spool 12 in the first direction to dispense the capillary line 14 with a desired tension level.

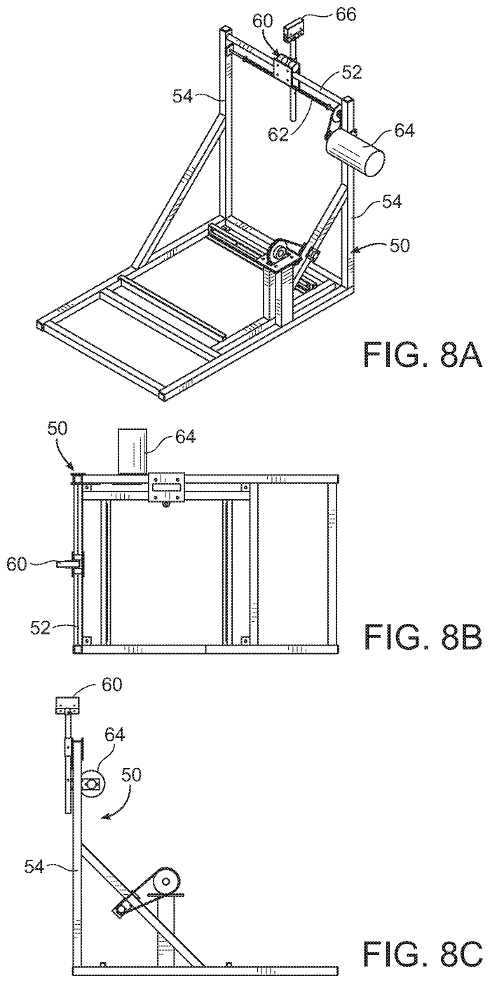

The first motor 70 may be comprised of various types of motors such as, but not limited to, a hydraulic motor or an electronic motor. The first motor 70 provides rotational force to the first axle 13 and the first spool 12. The first motor 70 may be connected to the first spool 12 by various devices to transfer the rotational force such as, but not limited to, a first chain connected between the first motor 70 and a gear attached to the first axle 13 as shown in FIGS. 1, 5, 6, 8A and 8B of the drawings. Alternative devices may also be used to transfer the rotational force to the first spool 12 such as, but not limited to, a belt, gearing, gear boxes, drive shafts and the like.

The first motor 70 preferably includes a tension controller to maintain a desired line tension in the capillary line 14 during unwinding or winding which prevents the capillary line 14 from binding or kinking. The tension within the capillary line 14 also ensures that the capillary line 14 is straight and taut thereby reducing the potential of the capillary line 14 from getting caught on anything or a worker prior to being secured to the tubing. The desired line tension may vary depending upon the type, size and length of capillary line 14 used. The desired line tension is preferably adjustable, but may be constant, during unwinding and winding of the capillary line 14 with respect to the first spool 12, but the desired line tension may vary depending upon the circumstances. To account for the constant changing weight on the first spool 12 (i.e. force it takes to rotate the first spool 12), the line tension will typically decrease during the installation of capillary line 14 and increase during the removal of capillary line 14. For example, if the first motor 70 is comprised of a hydraulic motor, the tension controller may include a pressure valve that is positioned inline between the first motor 70 and the hydraulic pressure source to regulate and control the hydraulic pressure within the hydraulic motor thereby maintaining a desired line tension within the capillary line 14 during unwinding and winding of the capillary line 14. The sensor 68 used with the level wind unit 60 may also provide feedback to the control unit 80 regarding the line tension in the capillary line 14 in a constant manner during unwinding and winding and the control unit 80 may control the pressure valve to adjust the hydraulic pressure within the motor thereby correspondingly adjusting the line tension within the capillary line 14. The desired line tension may be comprised of a range of tension (e.g. 10 lbs to 50 lbs) or an approximate tension force (e.g. 45 lbs).

### D. Second Spool Support.

FIGS. 1 through 3, 5 and 6 illustrate a second spool support 40 attached to the platform 32. The second spool support 40 is preferably attached to the upper surface of the platform 32 and extends upwardly from the platform 32. The second spool support 40 rotatably supports a second spool 16 having a length of cable line 18 that is spooled upon the second spool 16. The second spool 16 includes a second axle 17 to rotatably support the second spool 16 upon the second spool support 40 as shown in FIG. 2 of the drawings. The second spool 16 may be comprised of any spool structure and may have a central portion with opposing sidewalls defining a channel between the sidewalls that receives the cable line 18 (e.g. electric communications cable, electric power cable, fiber optic communications cable).

The cable line 18 is secured to the production tubing 11 used in an oil or gas well for providing electrical power and/or communications to/from devices (e.g. pump and motor) within the well. The cable line 18 may be comprised of various types cables used within the oil and gas industry. The cable line 18 is wound about the second spool 16 for storage and transportation as shown in FIGS. 2 and 3 of the drawings.

The second spool support 40 includes a pair of vertical supports that support the opposing portions of the second axle 17 extending through the second spool 16 as shown in FIGS. 1 through 3 and 6 of the drawings. The pair of vertical supports for the second spool support 40 elevate the second spool 16 above the upper surface of the platform 32 to allow for relatively free rotation of the second spool 16 upon the second spool support 40 without touching the upper surface of the platform 32 shown in FIG. 6 of the drawings.

FIGS. 1 through 3, 5 and 6 illustrate an exemplary embodiment showing the second spool support 40 comprised of a pair of arms 40 that are pivotally attached to the rear end of the platform 32 to load and unload the second spool 16 from the rear end of the motorized vehicle 30. Actuators 42 are connected between the platform 32 and the arms 40 to manipulate the position of the arms 40. The actuators may be comprised of hydraulic cylinders or electrical-mechanical actuators. When the arms 40 are lowered from the rear end of the motorized vehicle 30, the second axle 17 of the second spool 16 (positioned on the ground) is positioned upon cutouts in the distal ends of the arms 40 (FIG. 2) and then the arms may be raised to position the second spool 16 upon the motorized vehicle 30 for dispensing the cable line 18 (FIG. 3) or made ready for transportation.

In one embodiment, the second spool support 40 is aligned so that it supports the second axle 17 in a manner that is orthogonal to the longitudinal axis of the motorized vehicle 30 and the platform 32 of the motorized vehicle 30 as shown in FIGS. 2 and 3 of the drawings. Aligning the second axle 17 of the second spool 16 orthogonally with respect to the longitudinal axis of the motorized vehicle 30 allows the motorized vehicle 30 to position itself with the rear end of the motorized vehicle 30 near the workover rig 10 to save space near the workover rig 10, allows the cable line 18 to be dispensed (or collected) from the rear end of the motorized vehicle 30 as shown in FIGS. 1 and 3 of the drawings and allows workers to be able to load or unload the second spool 16 without use of an additional piece of equipment (ex. Forklift, loader, skidsteer).

A second motor 72 is preferably attached to the second spool support 40 or the platform 32 in an exemplary embodiment. The second motor 72 is adapted to be connected to the second spool 16 to rotate the second spool 16 about a second axis longitudinally extending through the second axle 17. The second motor 72 is preferably adapted to rotate the second spool 16 in a second direction to unspool the cable line 18 from the second spool 16 when installing tubing 11 to a well and a second direction to spool the cable line 18 upon the second spool 16 for when removing tubing 11 from a well.

The second motor 72 may be comprised of various types of motors such as, but not limited to, a hydraulic motor or an electronic motor. The second motor 72 provides rotational force to the second axle 17 and the second spool 16. The second motor 72 may be connected to the second spool 16 by various devices to transfer the rotational force such as, but not limited to, a second chain connected between the second motor 72 and a gear attached to the second axle 17 as shown in FIGS. 1 and 6 of the drawings. Alternative devices may also be used to transfer the rotational force to the second spool 16 such as, but not limited to, a belt, gearing, gear boxes, drive shafts and the like.

The second motor 72 may include a tension controller to maintain a desired line tension in the cable line 18 during unwinding or winding which prevents the cable line 18 from binding or kinking. With cable line 18 there is less of a problem of binding and kinking compared to capillary line 14 so a tension controller is not usually needed for the second motor 72. If a tension controller is used for the second motor 72, the tension controller may be the same system as used for the tension controller of the first motor 70 discussed previously.

The first axis of the first axle 13 is preferably parallel to the second axis of the second axle 17 when supported by the first spool support 50 and the second spool support 40 respective as shown in FIGS. 3 and 6 of the drawings. In addition, the first axis and the second axis are preferably orthogonal with respect to a longitudinal axis of the motorized vehicle 30 and the platform 32 to allow for unwinding and winding from the rear end of the vehicle. A center of the first axis and a center of the second axis are preferably positioned along a longitudinal axis of the motorized vehicle 30.

As shown in FIGS. 1 through 3 and 6, the first spool 12 and the second spool 16 are supported directly above the upper surface of the platform 32 so that the spools 12, 16 do not touch the upper surface of the platform 32. The second spool 16 is also preferably supported near the rear end of the motorized vehicle 30 to allow for the cable line 18 to be unwound or wound in a slacked manner without significant tension without interfering or touching anything as shown in FIGS. 1 and 3 of the drawings. The first spool 12 is preferably supported centrally above the platform 32 between the second spool 16 and the front end of the vehicle as shown in FIGS. 1 through 3 and 6 of the drawings.

### E. Level Wind Unit.

A level-wind unit may be attached to the platform 32 or the first spool support 50 where the capillary line 14 passes through a guide unit 66 of the level wind unit 60. The level wind unit 60 ensures that the capillary line 14 is wound uniformly and evenly upon first spool 12 when winding the capillary line 14 onto the first spool 12. The level-wind unit includes a pair of vertical members 54 that support the level-wind unit and the guide unit 66 in an elevated manner above the first spool 12 as shown in FIGS. 1 through 3, 5 and 6. An upper guide member 52 extends between the pair of vertical members 54 that the guide unit 66 is slidably positioned upon. A threaded shaft 62 connected to a motor 64 (e.g. hydraulic motor, electric motor) is threadably connected to the guide unit 66 causing the guide unit 66 to move back and forth to evenly guide the capillary line with respect to the first spool. The guide unit 66 may include rollers that support the cable line 18 during winding and unwinding of the cable line 18 in a relatively frictionless manner.

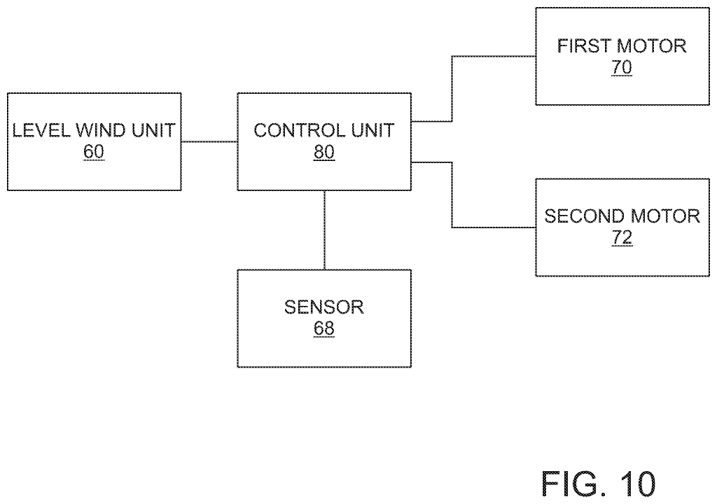

A sensor 68 is preferably connected to the guide unit 66 to detect the amount of tension within the capillary line 14. The sensor 68 is in communication with the control unit 80 as shown in FIG. 10 of the drawings. The sensor 68 is configured to calculate a line tension within the capillary line 14 during winding and unwinding of the capillary line 14 to ensure that a desired line tension is maintained. If the sensor 68 detects a lower than desired line tension within the capillary line 14, the control unit 80 can increase the tension within the capillary line 14 by applying more force to the first motor 70 if winding the capillary line 14 or less force to the first motor 70 if unwinding the capillary line 14 to create a drag effect. If the sensor 68 detects a higher than desired line tension within the capillary line 14, the control unit 80 can decrease the tension within the capillary line 14 by applying less force to the first motor 70 if winding the capillary line 14 or more force to the first motor 70 if unwinding the capillary line 14 to reduce the drag effect. Additionally a linear counter may be attached to the guide unit 66 to accurately count the length of capillary line 14 being installed or removed. A counter also assists the diagnostic team when a significant event occurs and the depth have been documented.

### F. Operation of Preferred Embodiment—Installation of Line.

During installation of the capillary line 14 and cable line 18 for an oil/gas workover rig 10, the first spool 12 is positioned upon the first spool support 50 and the second spool 16 is positioned upon the second spool support 40 as shown in FIGS. 1, 3 and 6 of the drawings. A worker drives the motorized vehicle 30 to the workover rig 10 and backs the motorized vehicle 30 to align the rear with the workover rig 10 as shown in FIGS. 1 and 3 of the drawings.

The capillary line 14 from the first spool 12 is fed through the guide unit 66 and over a first sheave 22 attached to the workover rig 10 as shown in FIGS. 1 and 3 of the drawings. The cable line 18 from the second spool 16 is fed over a second sheave 20 attached to the workover rig 10. The capillary line 14 and the cable line 18 extend downwardly from the sheaves 20, 22 next to the tubing 11 and will be secured to the ESP or associated component. The capillary line 14 and the cable line 18 are attached to the tubing 11 using conventional clamps 19 used to secure the capillary line 14 and cable line 18 to the exterior side of the tubing 11 being inserted into the well.

As the tubing 11 is lowered downwardly into the well, the first motor 70 and the second motor 72 simultaneously rotate the first spool 12 and the second spool 16 in the first direction to unwind the same from the spools 12, 16. The first motor 70 is controlled by the control unit 80 receiving tension data from the sensor 68 to ensure that a desired level of line tension exists within the capillary line 14 to maintain a smooth feed of the capillary line 14 over the first sheave 22 and down to the tubing 11. If the tubing 11 is stopped from moving downwardly to install another clamp 19 or for other reason, the control unit 80 stops the rotation of the first motor 70 and the second motor 72 to prevent unnecessary unspooling of the capillary line 14 and the cable line 18. Once the tubing 11 begins to be inserted again into the well, the control unit 80 activates the first motor 70 and the second motor 72 again to dispense the capillary line 14 and cable line 18 concurrently with the insertion of the tubing 11. This process continues until the tubing 11 is fully inserted into the well. Additional spools may be loaded upon the motorized vehicle 30 if needed. Once the capillary line 14 and the cable line 18 are fully installed and any remnants are secured, the motorized vehicle 30 may be driven to another workover rig 10 or a different location.

In one embodiment, tension controls the first motor 70 stop and go and a valve that is on the control panel 80. The second motor 72 stop and go is manually controlled by a worker using a foot pedal or remote type system as part of the control unit 80. The control unit 80 and associated control devices are generally designed to be used away from the unit. During a removal, the person standing between the cable spool and rig has the foot pedal that is in communication with the control unit 80.

### G. Operation of Preferred Embodiment—Removal of Line.

When removing capillary line 14 and cable line 18 from an oil or gas well during the removal of production tubing 11 from the well, the opposite procedure occurs. An empty first spool 12 and an empty second spool 16 are supported upon the first spool support 50 and the second spool support 40. The capillary line 14 attached to the tubing 11 is fed over the first sheave 22 attached to an upper portion of the workover rig 10 and downwardly through the guide unit 66 onto the first spool 12. Correspondingly, the cable line 18 attached to the tubing 11 is fed over the second sheave 20 attached to an upper portion of the workover rig 10 and downwardly to the second spool 16.

As the tubing 11 is removed from the well, the corresponding length of capillary line 14 and cable line 18 are wound upon the first spool 12 and the second spool 16 respectively by the first motor 70 and the second motor 72 rotating the spools 12, 16 in the second direction. During the winding of the capillary line 14, the sensor 68 constantly monitors the line tension providing tension data to the control unit 80 which then controls the line tension within the capillary line 14 by adjusting the force of the first motor 70 applied to the first spool 12 to ensure that a desired line tension exists in the capillary line 14 to prevent binding and kinking of the capillary line 14. If the removal of the tubing 11 stops, the control unit 80 stops the rotation of the first motor 70 and the second motor 72 which stops the rotation of the first spool 12 and second spool 16 correspondingly. Once the removal of the tubing 11 restarts, the control unit 80 activates the first motor 70 and the second motor 72 again to rotate in the second direction. This process continues until the tubing 11 is fully removed from the well. The capillary line 14 and the cable line 18 are secured to their respective spools and the motorized vehicle 30 is driven to a different location to unload the spools for diagnostics or the spools may be removed near the workover rig 10 for storage.

Unless otherwise defined, all technical and scientific terms used herein have the same meaning as commonly understood by one of ordinary skill in the art to which this invention belongs. Although methods and materials similar to or equivalent to those described herein can be used in the practice or testing of the combination capillary and cable spooling system, suitable methods and materials are described above. All publications, patent applications, patents, and other references mentioned herein are incorporated by reference in their entirety to the extent allowed by applicable law and regulations. The combination capillary and cable spooling system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A combination capillary and cable spooling system, comprising:
a motorized vehicle having a front end, a rear end, a plurality of wheels and a platform having an upper surface;
a first spool support attached to the upper surface of the platform, wherein the first spool support is adapted to rotatably support a first spool having a capillary line;
a first motor attached to the first spool support, wherein the first motor is adapted to be connected to the first spool to rotate the first spool about a first axis in a first direction to unspool the capillary line from the first spool or a second direction to spool the capillary line upon the first spool;
a second spool support attached to the upper surface of the platform, wherein the second spool support is adapted to rotatably support a second spool having a cable line; and
a second motor attached to the second spool support, wherein the second motor is adapted to be connected to the second spool to rotate the second spool about a second axis in a first direction to unspool the cable line from the second spool or a second direction to spool the cable line upon the second spool.

2. The combination capillary and cable spooling system of claim 1, wherein the first axis is parallel to the second axis.

3. The combination capillary and cable spooling system of claim 1, wherein the first spool and the second spool are supported directly above the upper surface of the platform.

4. The combination capillary and cable spooling system of claim 1, wherein the second spool is supported near the rear end of the motorized vehicle, and wherein the first spool is supported between the second spool and the front end of the vehicle.

5. The combination capillary and cable spooling system of claim 1, wherein a center of the first axis and a center of the second axis are positioned along a longitudinal axis of the motorized vehicle.

6. The combination capillary and cable spooling system of claim 1, wherein the first motor is connected to the first spool by a first chain and wherein the second motor is connected to the second spool by a second chain.

7. The combination capillary and cable spooling system of claim 1, wherein the first motor and the second motor are each comprised of a hydraulic motor.

8. The combination capillary and cable spooling system of claim 1, wherein the first motor includes a tension controller to maintain a desired line tension in the capillary line.

9. The combination capillary and cable spooling system of claim 1, including a plurality of ground support units attached to the motorized vehicle near the rear end, wherein the plurality of ground support units each are comprised of a telescoping structure that is adapted to engage a ground surface to support a portion of a weight of the motorized vehicle.

10. The combination capillary and cable spooling system of claim 1, wherein the second spool support is comprised of a pair of spool lift arms pivotally connected to the platform.

11. A combination capillary and cable spooling system, comprising:
a motorized vehicle having a front end, a rear end, a plurality of wheels and a platform having an upper surface;
a first spool support attached to the upper surface of the platform, wherein the first spool support is adapted to rotatably support a first spool having a capillary line;
a first motor attached to the first spool support, wherein the first motor is adapted to be connected to the first spool to rotate the first spool about a first axis in a first direction to unspool the capillary line from the first spool or a second direction to spool the capillary line upon the first spool;
a second spool support attached to the upper surface of the platform, wherein the second spool support is adapted to rotatably support a second spool having a cable line;
a second motor attached to the second spool support, wherein the second motor is adapted to be connected to the second spool to rotate the second spool about a second axis in a first direction to unspool the cable line from the second spool or a second direction to spool the cable line upon the second spool;
a level-wind unit attached to the platform or the first spool support, wherein the capillary line passes through a guide unit of the level wind unit; and
a sensor connected to the guide unit, wherein the sensor is configured to calculate a line tension within the capillary line.

12. The combination capillary and cable spooling system of claim 11, wherein the first axis is parallel to the second axis.

13. The combination capillary and cable spooling system of claim 11, wherein the first spool and the second spool are supported directly above the upper surface of the platform.

14. The combination capillary and cable spooling system of claim 11, wherein the second spool is supported near the rear end of the motorized vehicle, and wherein the first spool is supported between the second spool and the front end of the vehicle.

15. The combination capillary and cable spooling system of claim 11, wherein a center of the first axis and a center of the second axis are positioned along a longitudinal axis of the motorized vehicle.

16. The combination capillary and cable spooling system of claim 11, wherein the first motor is connected to the first spool by a first chain and wherein the second motor is connected to the second spool by a second chain.

17. The combination capillary and cable spooling system of claim 11, wherein the first motor and the second motor are each comprised of a hydraulic motor.

18. The combination capillary and cable spooling system of claim 11, wherein the first motor includes a tension controller to maintain a desired line tension in the capillary line.

19. The combination capillary and cable spooling system of claim 11, including a plurality of ground support units attached to the motorized vehicle near the rear end, wherein the plurality of ground support units each are comprised of a telescoping structure that is adapted to engage a ground surface to support a portion of a weight of the motorized vehicle.

20. A combination capillary and cable spooling system, comprising:
a motorized vehicle having a front end, a rear end, a plurality of wheels and a platform having an upper surface;
a first spool support attached to the upper surface of the platform, wherein the first spool support is adapted to rotatably support a first spool having a capillary line;
a first motor attached to the first spool support, wherein the first motor is adapted to be connected to the first spool to rotate the first spool about a first axis in a first direction to unspool the capillary line from the first spool or a second direction to spool the capillary line upon the first spool;
wherein the first motor is connected to the first spool by a first chain;
wherein the first motor includes a tension controller to maintain a desired line tension in the capillary line;
a second spool support attached to the upper surface of the platform, wherein the second spool support is adapted to rotatably support a second spool having a cable line;
wherein the second spool support is comprised of a pair of spool lift arms pivotally connected to the platform;
a second motor attached to the second spool support, wherein the second motor is adapted to be connected to the second spool to rotate the second spool about a second axis in a first direction to unspool the cable line from the second spool or a second direction to spool the cable line upon the second spool;
wherein the second motor is connected to the second spool by a second chain;
wherein the first motor and the second motor are each comprised of a hydraulic motor;
wherein the first axis is parallel to the second axis;
wherein the first axis and the second axis are orthogonal with respect to a longitudinal axis of the motorized vehicle;
wherein a center of the first axis and a center of the second axis are positioned along a longitudinal axis of the motorized vehicle;
wherein the first spool and the second spool are supported directly above the upper surface of the platform;
wherein the second spool is supported near the rear end of the motorized vehicle, and wherein the first spool is supported between the second spool and the front end of the vehicle;
a level-wind unit attached to the platform or the first spool support, wherein the capillary line passes through a guide unit of the level wind unit;
a sensor connected to the guide unit, wherein the sensor is configured to calculate a line tension within the capillary line; and
a plurality of ground support units attached to the motorized vehicle near the rear end, wherein the plurality of ground support units each are comprised of a telescoping structure that is adapted to engage a ground surface to support a portion of a weight of the motorized vehicle.
